(19) United States
(12) Patent Application Publication
(10) Pub. No.: US 2011/0041489 A1
(43) Pub. Date: Feb. 24, 2011

(54) METHOD AND AN APPARATUS FOR PRODUCING LIQUID FLOW IN A PIPELINE

(76) Inventor: Trond Melhus, Sandnes (NO)

Correspondence Address: GABLE & GOTWALS, 100 WEST FIFTH STREET, 10TH FLOOR, TULSA, OK, 74103, US

(21) Appl. No.: 12/935,479

(22) PCT Filed: Apr. 1, 2009
(86) PCT No.: PCT/NO09/00123

§ 371 Date: Nov. 1, 2010

(30) Foreign Application Priority Data
Apr. 10, 2008 (NO) 20061742

(51) Int. Cl. F15B 15/00

(52) U.S. Cl. 60/325

(57) ABSTRACT

A method and apparatus for producing liquid flow in a pipeline which is provided with at least one turbine device to extract energy from the liquid flow, wherein stream is used to produce liquid flow in the pipeline and through the turbine.

### CROSS-REFERENCE TO PENDING APPLICATIONS

This application is the United States National Phase of PCT Patent Application No. NO2009/00123 filed on 1 Apr. 2009, which was published in English on 15 Oct. 2009 under No. WO2009/126044A1, which claims priority of Norwegian Patent Application No. 20081742 filed 10 Apr. 2008, both of which are incorporated here by reference.

The present invention relates to a method and an apparatus for producing liquid flow in a pipeline. More particularly, it relates to a method and an apparatus for producing liquid flow in a pipeline which is provided with at least one turbine device to extract energy from the liquid flow.

It is known to use steam turbines, gas turbines or combustion engines to produce, for example, electrical energy. However, it is known that the efficiency of said equipment is relatively low, about 30-40%. This means that relatively much CO₂ is produced to provide the electrical energy. In addition, the equipment requires much so-called utility equipment, is complex and has relatively high maintenance costs.

Because of the above-mentioned drawbacks, the utilization of limited deposits or the limited production of combustible gases, such as methane, has been of little interest so far. Such limited deposits will typically be present in places where there is putrefaction of biological mass. Examples of such biological mass are residual products arising in connection with the production of foodstuffs, such as manure, slaughterhouse waste and vegetable waste.

Instead of utilizing the resource that such gases represent, it is common to let the gases be emitted into the atmosphere, either directly, by spreading as fertilizer on farm land, or after so-called flaring.

For a long time, so-called district heating plants, which are based on the distribution of heated water to a surrounding area, have been considered to be a relatively environmentally friendly solution. Such plants are considered to be particularly environmentally friendly when energy is based on the combustion of, for example, waste or CO₂-neutral energy sources, such as wood chips.

However, district heating plants have several drawbacks. Firstly, such plants require relatively large investment and operating costs. Secondly, there will be fluctuations in the demand for the heat produced at such plants. The demand will vary both through the day and through the season. Last but not least, the energy in the form of heated water has a short range and can only be distributed in the network connected to the district heating plant. It is only in areas of great industrial density that any surplus heat might sell.

Publication GB 162641 discloses an apparatus that utilizes pressurised steam to provide liquid flow in a pipe line.

Publication US 2007/0151234 A1 discloses a system for producing energy, where pressurised air is used to provide liquid flow to a water turbine.

The invention has for its object to remedy or reduce at least one of the drawbacks of the prior art.

The object is achieved through features which are specified in the description below and in the claims that follow.

In a first aspect of the present invention there is provided a method for producing liquid flow in a pipeline which is provided with at least one turbine device to extract energy from the liquid flow, wherein the method includes the steps of:
allowing steam at a first pressure to flow through a closable inlet into a container to displace a volume of liquid out through a closable outlet of the container and into the pipeline;
allowing the liquid flow to drive the turbine and allowing the liquid flow downstream of the turbine to return at a, relative to the pressure upstream of the turbine, lower pressure through a low-pressure line, via a buffer container and a liquid supply line to a second inlet of the container, said inlet being openable;
shutting off the supply of steam into the container;
allowing the pressure in the container to displace the liquid out of the container and through the turbine;
closing the outlet to the pipeline;
opening to fluid communication of steam out of the container; and
opening to filling liquid back into the container from the liquid supply line which is in fluid communication with the buffer container.

The energy supplied to the system in the form of steam which has been pressurized can be provided, in a manner known per se, by means of a steam boiler, for example.

To provide a flow of liquid as even as possible through the at least one turbine, it is an advantage if two or more containers are placed in parallel, the steps being run through with a phase lag between the individual containers.

In a preferred embodiment, at least one additional turbine is placed in each of at least one additional medium-pressure pipeline arranged for the at least one container, the pressure in the container being a control factor for liquid flow in the individual pipeline.

The liquid may thereby be controlled to flow successively into one or more medium-pressure liquid lines and through additional turbines which are optimized for liquid flow with a limited pressure range.

To be able to maintain steam and liquid balance in the apparatus as it is opened for the above-mentioned fluid communication of steam out of the container, a so-called pressure bleed, it is an advantage if the steam which is flowing out of the container into a pressure bleed line is carried via a heat exchanger and back into the liquid system via a buffer container. The fluid balance in the apparatus, which is closed to the surroundings in terms of fluid, is thereby maintained.

In an alternative embodiment the steam in the pressure bleed line is carried into the steam-generating device by means of a pumping device.

In a further alternative embodiment, the steam in the pressure bleed line is carried into the heat exchanger and pumped from that into the steam-generating device.

In both the alternatives mentioned above there is provided improved separation of steam and liquid in the apparatus. Also in the alternatives mentioned, the fluid balance in the apparatus is maintained.

In one embodiment, the pressure bleed line is provided with a steam turbine to extract energy from the steam flowing in the line. The steam turbine is disposed upstream of a possible heat exchanger.

It has turned out to be a great advantage if the turbine is a so-called volumetric turbine device. In one embodiment a so-called lobe pump is used as a turbine, the lobe pump being driven by the liquid flow in the pipeline. It is also a great advantage if the turbine is used to control the pressure downstream of the turbine in such a way that this pressure does not fall below a predetermined minimum pressure.

In a second aspect of the present invention there is provided an apparatus for producing liquid flow in a pipeline to drive at least one turbine disposed in the pipeline, the apparatus including at least one container which is arranged to hold steam and liquid, and steam, which has been directed into the container, being arranged to drive liquid out of the container through a closable outlet and into the pipeline which includes the turbine, the liquid, which has been forced out of the container at a first pressure, being connected in terms of fluid, via a buffer container, to a closable liquid inlet portion of the container, through which the liquid has been carried at a second pressure which is lower than said first pressure, the second pressure being higher than a residual pressure in the container, though.

To prevent condensation of the steam it is an advantage to isolate the steam as much as possible from the liquid, for example by the container being divided into a steam chamber and a liquid chamber by means of a floating piston, preferably made of a heat-insulating material.

To provide a flow of liquid as even as possible through the turbine, it is an advantage if two or more containers are arranged in parallel, the inflow and outflow of steam and liquid being controlled with a phase lag so that, for example, the emptying of a first container takes place while another container is being filled.

It is an advantage if the buffer container is placed in a portion of the apparatus between a downstream side of the turbine and the container. To maintain an overpressure within the apparatus, so that liquid may enter the container without the use of a pumping device, it is an advantage if the buffer container is a pressure container.

In a preferred embodiment, the steam-generating device is supplied with liquid from the buffer container, alternatively, or additionally, the steam-generating device is supplied with fluid from the pressure bleed line or from a possible heat exchanger connected to it in terms of fluid. A person skilled in the art will understand that the liquid or steam must be subjected to a pressure increase before being carried into the steam-generating device for such supply to take place.

In what follows is described an example of a preferred embodiment which is visualized in the accompanying drawing, in which:

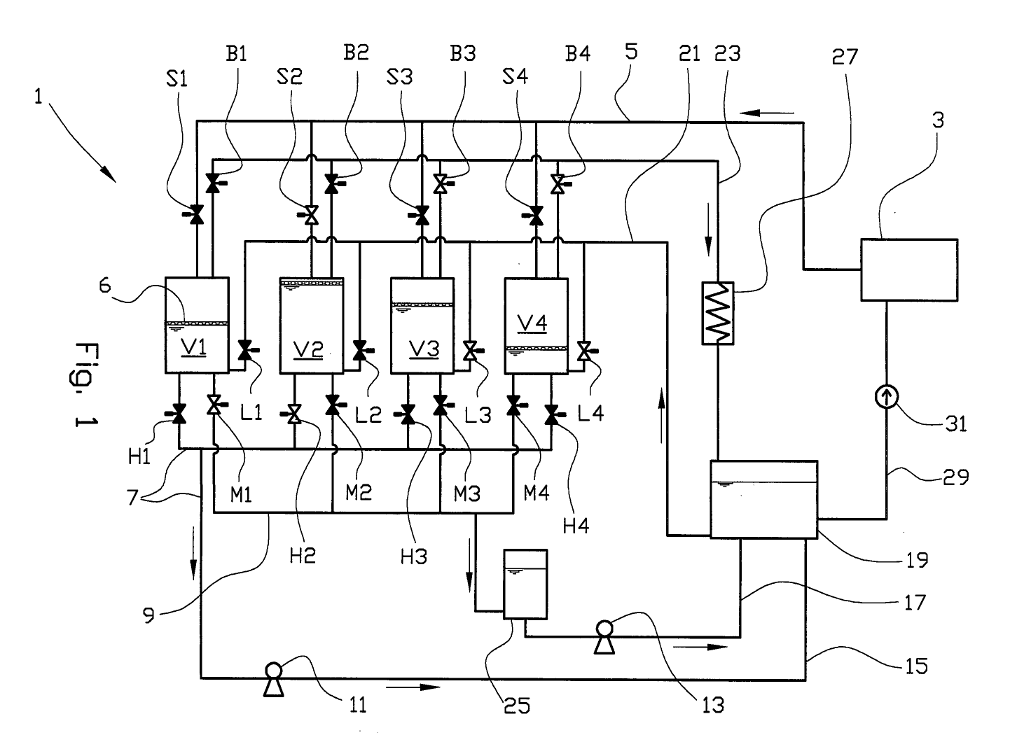

FIG. 1 shows a principle drawing of an apparatus in which steam is used to force liquid through two turbines which are placed in parallel in respective portions of a pipe coil. The principle drawing shows the apparatus in a given phase.

In the FIGURE the reference numeral 1 indicates an apparatus according to the invention, the apparatus being shown in a given phase or in a “momentary picture”.

The apparatus 1 is constituted by the following main components:
A steam boiler 3 of a kind known per se, carrying steam into a steam supply line 5;
four steam supply valves S1, S2, S3 and S4, each controlling the supply of steam through a top portion into a respective container V1, V2, V3 and V4;
a high-pressure liquid line 7 connected to a bottom portion of each of the containers V1, V2, V3, V4, a liquid flow out of the individual container V1, V2, V3 and V4 into the high-pressure liquid line 7 being controlled by means of respective high-pressure valves H1, H2, H3 and H4;
a medium-pressure liquid line 9 connected to a bottom portion of each of the containers V1, V2, V3, V4, liquid flow out of the individual container V1, V2, V3 and V4 into the medium-pressure liquid line 9 being controlled by means of a respective medium-pressure valve M1, M2, M3 and M4;
a first turbine 11 which is in fluid communication with the high-pressure liquid line 7 and a second turbine 13 which is is in fluid communication with the medium-pressure liquid line 9;
a first low-pressure liquid line 15 and a second low-pressure liquid line 17 which are connected to a downstream side of the first turbine, respectively the second turbine 13;
a buffer container 19 which is in fluid communication with the first low-pressure liquid line 15 and the second low-pressure liquid line 17;
a liquid supply line 21 extending between the buffer container 19 and a bottom portion of each of the containers V1, V2, V3 and V4, the liquid supply to the containers V1, V2, V3 and V4 being controlled by means of respective liquid supply valves L1, L2, L3 and L4;
a pressure bleed line 23 connected to a top portion of each of the containers V1, V2, V3 and V4, the pressure bleed from the individual container V1, V2, V3 and V4 being controlled by means of respective pressure bleed valves B1, B2, B3 and B4; and
a steam boiler supply line 29 carrying, by means of a pump 31, liquid from the buffer container 19 to the steam boiler 3.

The directions of flow in the individual pipelines are indicated by arrows in FIG. 1.

In the given phase, which is shown in FIG. 1, the steam supply valve S2 is open, whereas the steam supply valves S1, S3 and S4 are closed. Thus, in the given phase, vapour or steam from the steam boiler 3 flows only into the container V2. The steam boiler produces steam at a first pressure, which is 30 bars, for example. A person skilled in the art will understand that steam at a pressure different from the exemplary pressure indicated may be supplied.

The steam entering the container V2 displaces liquid, for example water, out through the high-pressure valve H2, which is open, into the high-pressure liquid line 7. The high-pressure valves H1, H3, H4 controlling liquid outflow from, respectively, the containers V1, V3 and V4, are in the closed position at the moment shown.

The liquid which is forced out of the container V2 into the high-pressure liquid line 7 flows through the first turbine 11. The first turbine 11 is a volumetric pumping device which is driven by the water flow, the pumping device being connected to, for example, a generator (not shown) for the production of electrical current. The volumetric pumping device is preferably constituted by a so-called lobe pump.

The energy extracted by the turbine 11, results in a pressure drop across the turbine 11. Downstream of the turbine 11 the pressure is reduced to a relatively low pressure, for example, but not limited to, in the order of 2-3 bars. It is desirable to maintain an overpressure downstream of the turbine 11 for the liquid to be able to flow through the low-pressure liquid lines 15, 17 and into the buffer container 19 and from there through the liquid supply line 21 into the respective container without the use of pumping devices which would require energy.

In FIG. 1, the container V1 is shown as it is approximately half filled with steam which has forced liquid out through the high-pressure liquid line 7 while the high-pressure valve H1 was in its open position. However, in the phase shown, the high-pressure valve H1 and the steam supply valve S1 are in the closed position whereas the medium-pressure valve M1 is in its open position. The pressure in the container V1 now forces the liquid out through the open medium-pressure valve M1, into the medium-pressure liquid line 9 and further into an accumulator container 25 for pressure equalization, from where the liquid flows through the second turbine 13. Downstream of the second turbine 13 the liquid flows via the second low-pressure line 17 into the buffer container 19.

It will be understood that a container (not shown), substantially corresponding to the accumulator container 25 disposed in the medium-pressure liquid line 9, can be disposed in the high-pressure liquid line 7.

In FIG. 1 the containers V3 and V4 are in the process of being filled with liquid from the buffer container 19. The container V3 has been filled about 80%, whereas the container V4 has been filled about 20% in the given phase.

To allow inflow of liquid into the containers V3 and V4 it will be understood that the liquid supply valves L3 and L4 are in an open position.

To prevent a residual pressure in the containers V3, V4 from counteracting the filling of liquid which is taking place at a relatively low pressure, for example 2-3 bars, the pressure bleed valves B3 and B4 are in an open position.

In the FIGURE, the pressure bleed line 23 is shown to be connected to a heat exchanger 27, known per se. The main purpose of the heat exchanger 27 is to condense the steam into liquid, so that the steam and liquid balance is maintained in the apparatus. As a positive side effect the heat exchanger 27 provides a certain suction of steam out of the respective container V1-V4. Another purpose is to utilize a portion of the thermal energy which is carried by the steam bled from the containers V1-V4. The thermal energy extracted may be used, for example, in connection with a biogas plant (not shown) which could be connected to the steam boiler 3.

As an alternative to the heat exchanger 27, steam which is bled through the pressure bleed line 23 can be carried directly to the buffer container 19. However, such a solution could mean that the steam bled may take a longer time in condensing and may consequently counteract effective bleeding of the containers V1-V4.

Liquid which is used in the production of steam in the steam boiler 3 is pumped from the buffer container 19 and into the steam boiler 3 through the steam boiler supply line 29 by means of a pump 31. The pump 31 is the only device besides the steam boiler 3 utilizing energy of any significance, as the energy required for operating the valves is considered to be relatively modest.

Even though, in the embodiment shown, the apparatus 1 is provided with four containers V1, V2, V3, V4, it will be understood that that the apparatus could also be constituted by one, two, three or more than four containers.

Whenever required, steam may be supplied to apparatuses which are connected in series, that is to say that two or more containers or sets of containers are connected in series.

In FIG. 1 it is shown that liquid may be forced into two alternative liquid lines 7, 9 and, from there, through associated turbines 11, 13. However, it will be understood that the apparatus may be provided with further liquid lines (not shown) which are each provided with a turbine (not shown).

It will be understood that the valves which are mentioned above are controlled by means of control devices known per se, which will be well known to a person skilled in the art.

Besides, a person skilled in the art will understand that at least the valves which are opened and closed to liquid flow are operated substantially in pressure balance. This is an advantage with respect to the use of energy necessary for operating the valves.

An emptying and filling cycle of the individual container will typically take place over the course of one to two minutes, even though it might also take place over a longer or shorter period. With such a typical emptying and filling cycle, a person skilled in the art will understand that the velocity of the liquid flow in the apparatus 1 will be relatively low. In a prototype of the apparatus the velocity was measured at 2.5-3 m/s, which results in relatively small flow losses and little erosion in the apparatus.

The apparatus 1 according to the present invention provides a closed, pressurized system which exhibits a very high efficiency, while the energy supplied to the steam boiler 3 may, at the same time, be converted into energy which can be distributed on an existing power supply network.

A person skilled in the art will be aware that steam may be provided by means of various energy sources, such as, but not limited to, fossil fuel, organic material, waste combustion, solar energy and surplus heat from the industry or a combination of one or more thereof.

By the very fact that a closed, pressurized system for the circulation of liquid is provided, the liquid temperature may be more than 100° C. and the system may be without any emission or exhaust of steam or liquid. To reduce uncontrolled heat loss to the surroundings and, thereby, loss of energy, all or parts of the apparatus 1 may be provided with a heat-insulating means.

Compared with known apparatuses for driving a turbine device by means of steam, the apparatus according to the present invention includes very few moving parts and therefore exhibits advantages as far as maintenance is concerned. Still, one of the most important benefits in relation to known apparatuses is the high efficiency of the apparatus, which has proved, in measurements, to be in the range of 60-70%. The simplicity of the apparatus combined with its high efficiency will make it economically beneficial to utilize energy carriers which have not been used until now.

Thus, from the above, a person skilled in the art will understand that the method and device according to the present invention represent a considerable environmental gain.

1. A method of producing liquid flow in a pipeline (7, 9) provided with at least one turbine device (11, 13) to extract energy from the liquid flow, characterized in that the method includes the steps of:
allowing steam at a first pressure to flow through a closable inlet into a container (V1-V4) to displace a volume of liquid out through a closable outlet of the container (V1-V4) and into the pipeline (7, 9);
allowing the liquid flow to drive the turbine (11, 13) and allowing the liquid flow downstream of the turbine (11, 13) to return at a, relative to the pressure upstream of the turbine, lower pressure through a low-pressure line (15, 17) via a buffer container (19) and a liquid supply line (21) to a second inlet of the container (V1-V4), the inlet being openable;
shutting off the supply of steam to the container (V1-V4);
allowing the pressure in the container (V1-V4) to displace the liquid out of the container (V1-V4);
closing the outlet into the pipeline (7, 9);
opening to fluid communication of steam out of the container (V1-V4); and
opening to filling liquid back into the container (V1-V4) from the liquid supply line (21) which is in fluid communication with the buffer container (19).

2. The method in accordance with claim 1, wherein two or more containers (V1-V4) are placed in parallel and wherein the steps are run through with a phase lag between the individual containers.

3. The method in accordance with claim 1, wherein the method comprises placing at least one further turbine (13) in each of the at least one further medium-pressure pipeline (9) arranged for the at least one container (V1-V4), the pressure in the container (V1-V4) being a control factor for liquid flow into the individual pipeline.

4. The method in accordance with claim 1, wherein steam which is communicated out of the container (1) is directed into a pressure bleed line (23) and carried via a heat exchanger (27) back into at least one of the buffer container (19) or a steam boiler (3) of the apparatus (1).

5. The method in accordance with claim 1 or 4, wherein steam which is communicated out of the container (1) is directed into a pressure bleed line (23) and carried via a steam turbine upstream of the possible heat exchanger back into at least one of the buffer container (19) or a steam boiler (3) of the apparatus (1).

6. The method in accordance with any one of the preceding claims, wherein there is used, for the turbine (11, 13), a volumetric turbine device.

7. The method in accordance with any one of the preceding claims, wherein the pressure in the low-pressure line (15, 17) downstream of the turbine (11, 13) is controlled by means of the turbine (11, 13).

8. An apparatus (1) for producing liquid flow in a pipeline (7, 9) to drive at least one turbine (11, 13) disposed in the pipeline (7, 9), characterized in that the apparatus (1) includes at least one container (V1-V4) which is arranged to hold steam and liquid, wherein steam which has been carried into the container (V1-V4) is arranged to drive liquid out of the container (V1-V4) through a closable outlet into the pipeline (7) including the turbine (11, 13), the liquid, which has been forced out of the container (V1-V4) at a first pressure, being connected in terms of fluid, via a buffer container (19), to a closable liquid inlet portion of the container (V1-V4), through which the liquid is carried at a second pressure which is lower than said first pressure, the second pressure being higher than a residual pressure in the container (V1-V4), though.

9. The apparatus in accordance with claim 8, wherein the container (V1-V4) is divided into a steam chamber and a liquid chamber by means of a floating piston (6).

10. The apparatus in accordance with claim 8 or 9, wherein two or more containers (V1-V4) are arranged in parallel, and wherein the inflow and outflow of steam and liquid are controlled in a phase-lagged manner.

11. The apparatus in accordance with any one of claims 8-10, wherein at least one further turbine (13) is placed in each of at least one further medium-pressure pipeline (9) which is arranged for the at least one container (V1-V4), the pressure in the container (V1-V4) being a control factor for into which one of the pipelines (7, 9) the liquid has been carried.

12. The apparatus in accordance to any one of claims 8-11, wherein the buffer container (19) is disposed in a portion of the apparatus (1) between a downstream side of the turbine (11, 13) and the container (V1-V4).

13. The apparatus in accordance with claim 12, wherein liquid which is used for the production of steam has been carried from the buffer container (19).

14. The apparatus in accordance with any one of the preceding claims, wherein the pressure in the low-pressure line (15, 17) downstream of the turbine (11, 13) is controlled by the turbine (11, 13).
